(19) United States
(12) Patent Application Publication
(10) Pub. No.: US 2024/0069740 A1
(43) Pub. Date: Feb. 29, 2024

(54) SYSTEMS AND METHODS FOR EXTENDING USEFUL LIFE OF SOLID STATE DRIVES

(71) Applicant: Dell Products L.P., Round Rock, TX (US)

(72) Inventor: Anthony GINTY, Douglas Cork (IE)

(73) Assignee: Dell Products L.P., Round Rock, TX (US)

(21) Appl. No.: 17/898,522

(22) Filed: Aug. 30, 2022

(51) Int. Cl. G06F 3/06

(52) U.S. Cl. CPC G06F 3/0616; G06F 3/0653; G06F 3/0679

(57) ABSTRACT

An information handling system may include a processor, a storage resource communicatively coupled to the processor, and logic configured to determine a maximum number of program/erase cycles capable of being performed without wearing out the storage resource, determine a number of program/erase cycles that have been performed, compare the number of program/erase cycles that have been performed to the maximum number of program/erase cycles capable of being performed without wearing out the storage resource, and take a remedial action if the number of program/erase cycles that have been performed is within a threshold relative to the maximum number of program/erase cycles capable of being performed without wearing out the storage resource.

### TECHNICAL FIELD

The present disclosure relates in general to information handling systems, and more particularly to systems and methods for extending the useful life of solid state drives in an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often include storage resources, also known as drives or hard drives, for storing programs and data. Increasingly, information handling systems employ solid state drives or flash drives to implement such storage resources. Despite their advantages, solid state drives have limited lifetimes due to the “wear-out” phenomenon unique to solid state drives. Generally speaking, due to the underlying physics used in implementing solid state drives, each “cell” for storing a bit of data in a solid state drive may wear out and cease to function after reaching a limited number of program/erase cycles to such cell.

To that end, a solid state drive may maintain within local metadata of the solid state drive a “percentage life used” indicator which may be read by a host system of an information handling system in order to monitor the solid state drive's health. A solid state drive may be flagged for removal once its percentage life used indicator approaches 100%.

However, in some instances, the percentage life used indicator may be based on a marketing-derived “writes per day” (WPD) endurance value which may be lower than an actual physical capability of a solid state drive for performing program-erase cycles. Accordingly, using existing approaches, a solid state drive may be tagged for removal while it still has significant remaining useful life remaining.

### SUMMARY

In accordance with the teachings of the present disclosure, the disadvantages and problems associated with existing approaches to tracking a life of a solid state drive may be reduced or eliminated.

In accordance with embodiments of the present disclosure, an information handling system may include a processor, a storage resource communicatively coupled to the processor, and logic configured to determine a maximum number of program/erase cycles capable of being performed without wearing out the storage resource, determine a number of program/erase cycles that have been performed, compare the number of program/erase cycles that have been performed to the maximum number of program/erase cycles capable of being performed without wearing out the storage resource, and take a remedial action if the number of program/erase cycles that have been performed is within a threshold relative to the maximum number of program/erase cycles capable of being performed without wearing out the storage resource.

In accordance with these and embodiments of the present disclosure, a method may include determining a maximum number of program/erase cycles capable of being performed without wearing out the storage resource, determining a number of program/erase cycles that have been performed, comparing the number of program/erase cycles that have been performed to the maximum number of program/erase cycles capable of being performed without wearing out the storage resource, and taking a remedial action if the number of program/erase cycles that have been performed is within a threshold relative to the maximum number of program/erase cycles capable of being performed without wearing out the storage resource.

In accordance with these and embodiments of the present disclosure, an article of manufacture may include a non-transitory computer readable medium and computer-executable instructions carried on the computer readable medium, the instructions readable by a processor, the instructions, when read and executed, for causing the processor to: determine a maximum number of program/erase cycles capable of being performed without wearing out the storage resource, determine a number of program/erase cycles that have been performed, compare the number of program/erase cycles that have been performed to the maximum number of program/erase cycles capable of being performed without wearing out the storage resource, and take a remedial action if the number of program/erase cycles that have been performed is within a threshold relative to the maximum number of program/erase cycles capable of being performed without wearing out the storage resource.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a flow chart of an example method for extending a useful life of a solid state drive, in accordance with embodiments of the present disclosure; and

FIG. 3 illustrates a flow chart of another example method for extending a useful life of a solid state drive, in accordance with embodiments of the present disclosure.

### DETAILED DESCRIPTION

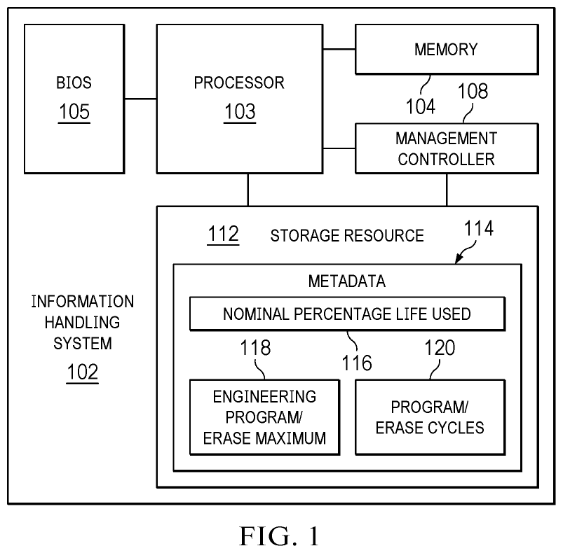

Preferred embodiments and their advantages are best understood by reference to FIGS. 1 through 3, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input and output (“I/O”) devices, such as a keyboard, a mouse, and a video display. The information handling system may also include one or more buses operable to transmit communication between the various hardware components.

For the purposes of this disclosure, information handling resources may broadly refer to any component system, device or apparatus of an information handling system, including without limitation processors, buses, memories, input-output devices and/or interfaces, storage resources, network interfaces, motherboards, electro-mechanical devices (e.g., fans), displays, and power supplies.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (“RAM”), read-only memory (“ROM”), electrically erasable programmable read-only memory (“EEPROM”), and/or flash memory; as well as communications media such as wires, optical fibers, microwaves, radio waves, and other electromagnetic and/or optical carriers; and/or any combination of the foregoing.

Information handling systems often use an array of physical storage resources (e.g., disk drives), such as a Redundant Array of Independent Disks (“RAID”), for example, for storing information. Arrays of physical storage resources typically utilize multiple disks to perform input and output operations and can be structured to provide redundancy which may increase fault tolerance. Other advantages of arrays of physical storage resources may be increased data integrity, throughput and/or capacity. In operation, one or more physical storage resources disposed in an array of physical storage resources may appear to an operating system as a single logical storage unit or “logical unit.” Implementations of physical storage resource arrays can range from a few physical storage resources disposed in a chassis, to hundreds of physical storage resources disposed in one or more separate storage enclosures.

FIG. 1 illustrates a block diagram of an example information handling system 102, in accordance with embodiments of the present disclosure. In some embodiments, information handling system 102 may comprise a server. In these and other embodiments, information handling system 102 may comprise a personal computer. In other embodiments, information handling system 102 may be a portable computing device (e.g., a laptop, notebook, tablet, handheld, smart phone, personal digital assistant, etc.). As depicted in FIG. 1, information handling system 102 may include a processor 103, a memory 104 communicatively coupled to processor 103, a BIOS 105 communicatively coupled to processor 103, a management controller 108 communicatively coupled to processor 103, and a storage resource 112 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, BIOS 105, storage resources 112, and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

BIOS 105 may be communicatively coupled to processor 103 and may include any system, device, or apparatus configured to identify, test, and/or initialize information handling resources of information handling system 102. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be read by and executed on processor 103 to carry out the functionality of BIOS 105. In these and other embodiments, BIOS 105 may comprise boot firmware configured to be the first code executed by processor 103 when information handling system 102 is booted and/or powered on. As part of its initialization functionality, code for BIOS 105 may be configured to set components of information handling system 102 into a known state, so that one or more applications (e.g., an operating system or other application programs) stored on compatible media (e.g., memory 104) may be executed by processor 103 and given control of information handling system 102.

Management controller 108 may be configured to provide management facilities for management of information handling system 102. Such management may be made by management controller 108 even if information handling system 102 is powered off or powered to a standby state. Management controller 108 may include any suitable components for carrying out its functionality, including without limitation a processor, memory, and a network interface separate from and physically isolated from an in-band network interface of information handling system 102. In certain embodiments, management controller 108 may include or may be an integral part of a baseboard management controller (BMC), a remote access controller (e.g., a Dell Remote Access Controller or Integrated Dell Remote Access Controller), or an enclosure controller. In other embodiments, management controller 108 may include or may be an integral part of a chassis management controller (CMC).

Storage resource 112 may be disposed in one or more storage enclosures configured to hold and power storage resource 112. Storage resource 112 may include hard disk drives, magnetic tape libraries, optical disk drives, magneto-optical disk drives, compact disk drives, compact disk arrays, disk array controllers, Non-Volatile Memory Express (NMVe) storage resources, and/or any other system, apparatus or device operable to store media. In particular embodiments, storage resource 112 may include a solid state drive.

As shown in FIG. 1, in addition to the programs and instructions that may be stored within the storage media of storage resource 112, storage resource 112 may include an area of storage for storing metadata 114 relating to operational parameters of storage resource 112. Such metadata 114 may include a nominal percentage life used variable 116, an engineering program/erase max variable 118, and a program/erase cycles variable 120.

Nominal percentage life used variable 116 may track a percentage of the nominal life of storage resource 112 that has been used in accordance with a useful life of storage resource 112 stated by a manufacturer or vendor of storage resource 112. Thus, nominal percentage life used variable 116 may be based on a marketing claim of useful life for storage resource 112.

To illustrate, storage resource 112 may be specified by its manufacturer or vendor to achieve a specific number of program/erase cycles based on a “drive writes per day” endurance value. Typical stated drive writes per day endurance values stated by drive manufacturers and vendors include 1 write per day and 3 writes per day.

Based on such stated drive writes per day, a number of maximum program/erase cycles may be calculated and used as a denominator for determining nominal percentage life used variable 116, with an actual number of program/erase cycles being used as the denominator. For example, the number of maximum program/erase cycles may be calculated by:

maxPEcycles=DWD×Days Per Life×WAF)/(1+OP)

where:
DWD equals the stated drive writes per day for storage resource 112;
WAF equals a write amplification factor of storage resource 112;
Days Per Life equals a number of days in the warranty period other nominally stated period of a duration of the lifetime of storage resource 112; and
OP equals the overprovisioning of storage resource 112.

Overprovisioning refers to a need for a solid state drive to have more physical flash capacity available than the logical capacity so that storage resource 112 can perform garbage collection processes. The write amplification factor refers to the fact that when data is written to a solid state drive, it may be written internally many times to the solid state drive, due to physics of flash cells which require that each flash cell be erased before being written to.

A manufacturer/vendor of a solid state drive may generally design a family of solid state drives in various capacities (e.g., 500 GB, 1 TB, 2 TB, 4 TB, 8 TB, 16 TB), and may make solid state drives available in different drive writes per day endurance values (e.g., 1 write per day, 3 writes per day). One main difference between 1 write per day and 3 writes per day solid state drives is that they may have different overprovisioning values, with a 3 writes per day solid state drive typically having greater overprovisioning than a 1 write per day drive. Overprovisioning may also vary as a function of capacity of a solid state drive.

Consider the Following Hypothetical Scenario:
A manufacturer/vendor's flash is characterized so that its maximum number of program/erase cycles (maxPEcycles) is 10,000. Thus, the solid state drive may operate within its safe operating limits as long as the number of program/erase cycles remains under 10,000.
A 1 TB, 1 drive write per day solid state drive could have 7% overprovisioning and a write amplification factor of 5, meaning that, in accordance with the equation above, such solid state drive would reach its 100% of nominal percentage life used at 8,528 program/erase cycles.
A 2 TB, 1 drive write per day solid state drive could have a 15% overprovisioning and a write amplification factor of 3, meaning that, in accordance with the equation above, such solid state drive would reach its 100% of nominal percentage life used at 4,761 program/erase cycles. However, the flash cells may be capable of 10,000 program/erase cycles (slightly more than 2 writes per day), but may be marketed as 1 write per day as no 2 write per day “marketing swimlane” may exist.

To overcome this disadvantage, management controller 108 may obtain (e.g., via a sideband communication interface) from storage resource 112 an indication of the engineering program/erase max variable 118 and a number of completed program/erase cycles 120 on storage resource 112, and may determine remaining useful drive life based on a comparison of number of completed program/erase cycles 120 and engineering program/erase max variable 118 (e.g., communicating an alert when completed program/erase cycles 120 is within a particular threshold of engineering program/erase max variable 118), rather than relying on nominal percentage life used variable 116 reported by storage resource 112.

In addition to processor 103, memory 104, BIOS 105, management controller 108, and storage resource 112, information handling system 102 may include one or more other information handling resources.

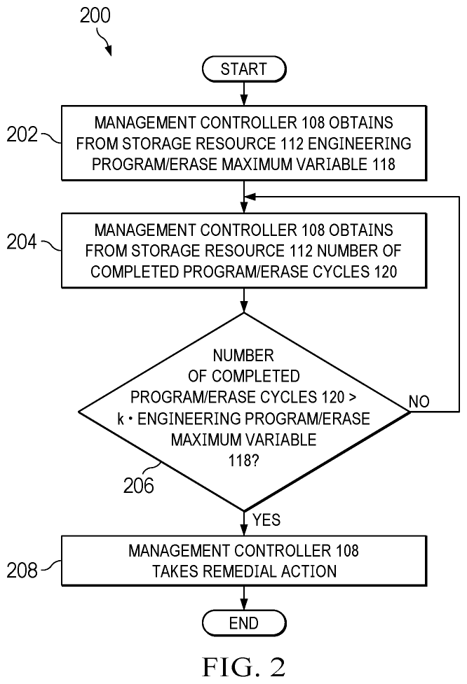

FIG. 2 illustrates a flow chart of an example method 200 for extending a useful life of a solid state drive, in accordance with embodiments of the present disclosure. According to certain embodiments, method 200 may begin at step 202. As noted above, teachings of the present disclosure may be implemented in a variety of configurations of information handling system 102 as shown in FIG. 1. As such, the preferred initialization point for method 200 and the order of the steps comprising method 200 may depend on the implementation chosen.

At step 202, management controller 108 may obtain from storage resource 112 engineering program/erase max variable 118. At step 204, management controller 108 may obtain from storage resource 112 number of completed program/erase cycles 120. At step 206, management controller 108 may compare number of completed program/erase cycles 120 to engineering program/erase max variable 118 to determine whether number of completed program/erase cycles 120 exceeds engineering program/erase max variable 118 multiplied by a factor k, wherein k may be a ratio between 0 and 1. If number of completed program/erase cycles 120 exceeds engineering program/erase max variable 118 multiplied by factor k, method 200 may proceed to step 208. Otherwise, method 200 may return again to step 204.

At step 208, in response to number of completed program/erase cycles 120 exceeding engineering program/erase max variable 118 multiplied by factor k, management controller 108 may take a remedial action. Such remedial action may include any appropriate action. For example, a remedial action may include communicating an alert to a user or administrator of information handling system 102 to remove and replace storage resource 112. As another example, in an information handling system 102 that includes an inactive spare storage resource 112, such remedial action may include activating the spare storage resource 112 and replicating data from the worn-out storage resource 112 to the spare storage resource 112 and using the spare storage resource 112 in lieu of the worn-out storage resource. After completion of step 208, method 200 may end.

Although FIG. 2 discloses a particular number of steps to be taken with respect to method 200, it may be executed with greater or lesser steps than those depicted in FIG. 2. In addition, although FIG. 2 discloses a certain order of steps to be taken with respect to method 200, the steps comprising method 200 may be completed in any suitable order.

Method 200 may be implemented using information handling system 102, components thereof, or any other suitable system operable to implement method 200. In certain embodiments, method 200 may be implemented partially or fully in software and/or firmware embodied in computer-readable media.

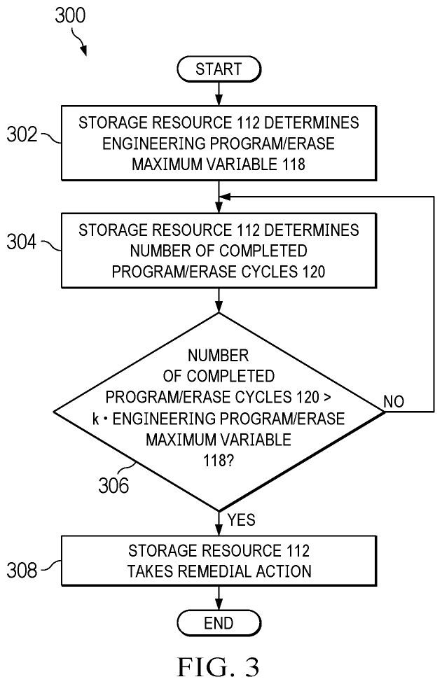

FIG. 3 illustrates a flow chart of another example method 300 for extending a useful life of a solid state drive, in accordance with embodiments of the present disclosure. According to certain embodiments, method 300 may begin at step 302. As noted above, teachings of the present disclosure may be implemented in a variety of configurations of information handling system 102 as shown in FIG. 1. As such, the preferred initialization point for method 300 and the order of the steps comprising method 300 may depend on the implementation chosen.

At step 302, storage resource 112 may determine engineering program/erase max variable 118. At step 304, storage resource 112 may determine a number of completed program/erase cycles 120. At step 306, storage resource 112 may compare number of completed program/erase cycles 120 to engineering program/erase max variable 118 to determine whether number of completed program/erase cycles 120 exceeds engineering program/erase max variable 118 multiplied by a factor k, wherein k may be a ratio between 0 and 1. If number of completed program/erase cycles 120 exceeds engineering program/erase max variable 118 multiplied by factor k, method 300 may proceed to step 308. Otherwise, method 300 may return again to step 304.

At step 308, in response to number of completed program/erase cycles 120 exceeding engineering program/erase max variable 118 multiplied by factor k, storage resource 112 may take a remedial action. Such remedial action may include any appropriate action. For example, such remedial action may include communicating an indication to management controller 108 that storage resource 112 is at or near the end of its useful life. In response to such communication, management controller 108 may take its own remedial action (e.g., communicating an alert to a user or administrator of information handling system 102 to remove and replace storage resource 112, automatically swapping the worn-out storage resource 112 for a spare storage resource 112, etc.). After completion of step 308, method 300 may end.

Although FIG. 3 discloses a particular number of steps to be taken with respect to method 300, it may be executed with greater or lesser steps than those depicted in FIG. 3. In addition, although FIG. 3 discloses a certain order of steps to be taken with respect to method 300, the steps comprising method 300 may be completed in any suitable order.

Method 300 may be implemented using information handling system 102, components thereof, or any other suitable system operable to implement method 300. In certain embodiments, method 300 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

1. An information handling system comprising:
a processor;
one or more storage resources communicatively coupled to the processor; and
logic configured to:
determine a maximum number of program/erase cycles capable of being performed without wearing out an individual storage resource;
determine a number of program/erase cycles that have been performed;
compare the number of program/erase cycles that have been performed to the maximum number of program/erase cycles capable of being performed without wearing out the individual storage resource; and
take a remedial action if the number of program/erase cycles that have been performed is within a threshold relative to the maximum number of program/erase cycles capable of being performed without wearing out the individual storage resource.

2. The information handling system of claim 1, wherein the one or more storage resources comprises one or more solid state drives.

3. The information handling system of claim 1, wherein the remedial action comprises communicating an alert to a person.

4. The information handling system of claim 1, wherein the remedial action comprises swapping the individual storage resource to a spare storage resource.

5. The information handling system of claim 1, wherein the logic is configured to take the remedial action on the basis of comparison of the number of program/erase cycles that have been performed to the maximum number of program/erase cycles capable of being performed without wearing out the individual storage resource, independent from an indication from the individual storage resource that the individual storage resource has reached or is close to reaching 100 percent of its nominal useful life.

6. The information handling system of claim 1, wherein the logic is embodied in a management controller communicatively coupled to the processor and the one or more storage resources and configured to perform management of the information handling system.

7. The information handling system of claim 1, wherein the logic is embodied within the one or more storage resources.

8. A method comprising:
determining a maximum number of program/erase cycles capable of being performed without wearing out a individual storage resource;
determining a number of program/erase cycles that have been performed;
comparing the number of program/erase cycles that have been performed to the maximum number of program/erase cycles capable of being performed without wearing out the individual storage resource; and
taking a remedial action if the number of program/erase cycles that have been performed is within a threshold relative to the maximum number of program/erase cycles capable of being performed without wearing out the individual storage resource.

9. The method of claim 8, wherein the individual storage resource comprises a solid state drive.

10. The method of claim 8, wherein the remedial action comprises communicating an alert to a person.

11. The method of claim 8, wherein the remedial action comprises swapping the individual storage resource to a spare storage resource.

12. The method of claim 8, further comprising taking the remedial action on the basis of comparison of the number of program/erase cycles that have been performed to the maximum number of program/erase cycles capable of being performed without wearing out the individual storage resource, independent from an indication from the individual storage resource that the individual storage resource has reached or is close to reaching 100 percent of its nominal useful life.

13. The method of claim 8, wherein the method is performed by a management controller communicatively coupled to the processor and the individual storage resource and configured to perform management of the information handling system.

14. The method of claim 8, wherein the method is performed by the individual storage resource.

15. An article of manufacture comprising:
a non-transitory computer readable medium; and
computer-executable instructions carried on the computer readable medium, the instructions readable by a processor, the instructions, when read and executed, for causing the processor to:
determine a maximum number of program/erase cycles capable of being performed without wearing out an individual storage resource;
determine a number of program/erase cycles that have been performed;
compare the number of program/erase cycles that have been performed to the maximum number of program/erase cycles capable of being performed without wearing out the individual storage resource; and
take a remedial action if the number of program/erase cycles that have been performed is within a threshold relative to the maximum number of program/erase cycles capable of being performed without wearing out the individual storage resource.

16. The article of claim 15, wherein the individual storage resource comprises a solid state drive.

17. The article of claim 15, wherein the remedial action comprises communicating an alert to a person.

18. The article of claim 15, wherein the remedial action comprises swapping the individual storage resource to a spare storage resource.

19. The article of claim 15, the program of instructions for further causing the processor to take the remedial action on the basis of comparison of the number of program/erase cycles that have been performed to the maximum number of program/erase cycles capable of being performed without wearing out the individual storage resource, independent from an indication from the individual storage resource that the individual storage resource has reached or is close to reaching 100 percent of its nominal useful life.

20. The article of claim 15, wherein the computer readable media is embodied in a management controller communicatively coupled to the processor and the individual storage resource and configured to perform management of the information handling system.

21. The article of claim 15, wherein the computer readable media is embodied in within the individual storage resource.
